(19) United States
(12) Patent Application Publication
(10) Pub. No.: US 2003/0072934 A1
(43) Pub. Date: Apr. 17, 2003

(54) Panel for architectural design

(76) Inventor: Rem Koolhaas, Rotterdam (NL)

Correspondence Address: BROWN, RAYSMAN, MILLSTEIN, FELDER & STEINER LLP, 900 THIRD AVENUE, NEW YORK, NY, 10022, US

(21) Appl. No.: 10/233,335

(22) Filed: Aug. 30, 2002

Related U.S. Application Data
(60) Provisional application No. 60/316,355, filed on Aug. 31, 2001.

(51) Int. Cl. B32B 3/26; E04C 3/30

(52) U.S. Cl. 428/304.4; 52/576

(57) ABSTRACT

This invention provides a web or a matrix for panels useful in architectural design, such as for exterior architectural panels, panels for interior partitions or for space delimiters, wall or ceiling architectural panels, tables, shelves, etc. More particularly, a web for a panel useful in architectural design comprising a structural web or matrix having a plurality of voids disposed in an apparent random configuration, where some of the voids communicate with an outer surface of the panel and where some of the voids may also communicate among themselves to give the panels a perforated appearance, similar to that of a sponge, and methods of manufacture thereof.

### PRIORITY CLAIM

This application claims priority from U.S. Provisional Application No. 60/316,355, entitled “Panel for Architectural Design”, filed Aug. 31, 2001. The entire contents of the Provisional Application No. 60/316,355, including the Appendix, are hereby incorporated herein by reference.

### COPYRIGHT NOTICE

A portion of the disclosure of this patent document and of the incorporated references contains material which is subject to copyright protection. The copyright owner has no objection to the facsimile reproduction by anyone of the patent document or the patent disclosure, as it appears in the United States Patent and Trademark Office patent files or records, in the event that this disclosure is made a matter of public record, but otherwise reserves all copyrights whatsoever.

### BACKGROUND OF THE INVENTION

This invention relates to panels useful in architectural design, such as for exterior architectural panels, panels for interior partitions or for space delimiters, and wall or ceiling architectural panels. More particularly, the invention relates to panels useful in architectural design comprising structural webs or matrices having voids disposed therein.

There have been various designs utilized for panels useful in architectural design. For example, exterior architectural panels used in modular and high-rise building construction typically incorporate design elements in a solid surface material such as concrete, metal, glass, stone, or plaster. Perforations, i.e., holes, may be included in architectural panels for items such as windows or doors, and also may be included to accommodate mechanical or electrical systems. It has generally been considered desirable, however, to reduce the number of perforations or design elements giving the appearance of perforations in order to maximize the overall performance of the completed structure, for example, with respect to natural forces such as wind and rain and to improve strength. Interior panels, such as those used as interior partitions or space delimiters, have generally limited the number of perforations in order to reduce sound and light transmission between delineated spaces.

In some instances, perforations or design elements giving the appearance of perforations have been purposefully incorporated into panels for either sound absorption and diffusion, or for aesthetic purposes. Examples of such architectural panels can be found in U.S. Pat. Nos. 2,280,631, 4,207,964, 4,122,915, 6,004,652, and 6,319,572, hereby incorporated herein by reference. The perforated architectural panels appearing in these patents, however, generally include perforations or design units arranged in a uniform, clearly non-random manner, such as on a grid pattern, thereby diminishing a desirable quality that the panel appear as if naturally occurring.

### SUMMARY OF THE INVENTION

The invention provides structural webs or matrices for panels useful in architectural designs, having pluralities of voids disposed in non-uniform and preferably apparently random configurations, with some of the voids communicating with, or breaching, at least one outer surface of the panels, wherein some of the voids may also communicate among themselves to give the panel a perforated appearance, and methods of manufacture thereof. An apparent random configuration generally denotes an arrangement for voids wherein recurring design details are not readily visible to an observer, as would be the case with tessellating patterns. An apparent random configuration may include an arrangement wherein voids are in fact randomly distributed, as well as an arrangement where voids are configured to appear randomly distributed, if for example, the non-uniform voids are located according to a mathematical algorithm. Optionally, voids may also communicate with each other, thereby creating patterns of greater complexity.

Panels incorporating webs according to this invention may contain voids configured in various ways, and of various shapes, such as voids having substantially spherical shapes, or otherwise continuously curved shapes, such as ellipsoids, or voids having substantially flat surfaces, such as rectangular, cubic, and other polyhedronic shapes, or a combination of curved and substantially flat surfaces, such as conical, cylindrical and parabolic shapes. Voids may be either of constant and/or various sizes, and may be dispersed either throughout the interiors and surfaces of the panels, or in localized portions of the panels. Voids communicating with an outer surface of a panel may be required not to communicate with an opposite panel surface either directly or indirectly, i.e., communicating with another void that also communicates with an opposite surface, thereby minimizing light and sound transmission. Alternatively, or additionally, voids may be disposed to communicate with opposite surfaces either directly or indirectly. The voids may be of various sizes to allow, for example, a desired amount of light and sound transmission or airflow.

Webs and panels according to this invention may be freestanding or hanging architectural panels or partitions, as wall or ceiling panels for covering all, or portions of walls or ceilings, or in any other manner in which architectural panels may be used. The panels may also be incorporated into relocateable or movable partition systems, such as in systems in which partitions are hung by ceiling-mounted tracks to provide flexible, functional, and aesthetically-pleasing systems of partitions or dividers. Panels according to this invention additionally may be used as structural elements such as walls, ceilings, beams, or columns, and can also be stacked or otherwise configured for use as shelves, lofts, tables, etc. Such panels may be sufficiently strong to act as structural members without other support, they may or incorporate structural members such as frames, trusses, or any other type of structural support systems. The panels according to this invention may be used to provide support for hanging objects such as clothing on hangers or other items intended for display.

The external overall shape of panels according to this invention may vary to accommodate desired applications. Wide latitude is afforded to designers in selecting the overall shape. For example, panels may be rectangular, oval, or of any other shape or shapes dictated or suggested either by their purpose, or by the creativity of the designers. Suitable external overall shapes for panels according to the invention will not trouble designers having ordinary skill in the relevant arts once the designers have been made familiar with the present disclosure.

Due to their highly novel configuration, panels according to this invention offer a number of unique advantages. When stood or hung such that at least one of the perforated surfaces is sufficiently vertically oriented, they may be used to support hanging or mounted objects such as clothing on hangers, lamps, pictures, etc., suitably attached thereto. When made of suitably colored, reflective, or translucent materials, they may be used to provide unique and highly aesthetic sound and lighting variations. The panels' shape and construction, and the choice of materials for manufacture may be used to tailor or modify sound reflection, for example by using anechoic properties of the panels to reduce or eliminate sound reflection.

Any suitable method of production may be employed to manufacture panels incorporating the web according to the invention. Panels may be carved, milled, molded, hollowed out, or otherwise formed from solid panels or sheet materials. Milled, carved, and hollowed panels may be produced by hand or by machine, for example, using a multi-axis milling machine. Panels may also be cast by placing small balls or balloons in a mold, such as a mold having a rectangular or other desired overall panel shape, and placing a suitable material capable of setting or curing into a suitably rigid structure, such as resin, within the mold containing the balls or balloons. A suitably rigid structure generally denotes a rigidity suited for a particular use. For example, a suitably rigid structure for panels intended to be used as structural elements may be achieved with a material such as concrete. Alternatively or in addition, the rigidity and the corresponding strength of the structure can be altered or enhanced by incorporating various structural elements or members within the panel, such as for example, wire fabric or mesh, frames, trusses, etc. cast or placed therein. After the material placed in the mold has set or cured, the balloons or balls used in the casting process may be removed, either destructively or non-destructively.

In some instances, it may be advantageous to provide panels having voids disposed in predetermined locations or configurations and with complementary shapes, such that edges of the panels, i.e., the webs, and voids located at the edges of the panels may meet seamlessly without apparent discontinuity. Voids may be located in non-uniform or apparently random dispositions while retaining the seamlessly joined appearance. This facilitates, for example, abutting panels to give the appearance of a single apparently seamless panel or web. Abutting generally denotes assembling panels such that an outer surface of a panel touches an outer surface of another panel. Abutting therefore includes the stacking, or otherwise assembling, panels to give the appearance of a single panel. This can be accomplished, for example, through the use of standard molds or automated material-shaping machines such as computer-programmed milling machines.

Panels according to the invention may be fabricated for the purposes contemplated from any material having suitable properties, including, but not limited to, sufficient strength, durability, corrosion resistance, and in some cases translucency and sound reflection or absorption capability. This will be well understood, for example, by interior systems designers, once they have been made familiar with the present disclosure. For example, flexible and highly durable panels may be made from polymers or plastics such as polyester resin, polyurethane (PU), including PU resin (PUR) (F18), PUR rubber, silicone rubber, and the like. Such materials can be especially advantageous since these materials offer a wide selection in colors, degrees of translucency, and sound and light reflecting or absorbing characteristics while retaining sufficient rigidity and strength to serve as interior or exterior partitions or panels. Similarly, fire resistance may be controlled through selection of suitable materials and coatings. Panels may also be made of non-polymers such as metals, woods, and plasters. Through the use of suitable additives, tints, and paints, translucent and/or opaque panels of any desired color and surface texture may be produced or enhanced. For coloring of opaque panels, molding, immersion, or spray painting can be especially effective.

The strength and stability of the panel, and the sound or light reflective properties of the same may also be tailored for the particular application by controlling the overall shape, i.e., length, width, and height of individual panels, and by controlling the character of voids therein, such as the size of the voids, the percentage of the overall nominal volume of the panel that the voids occupy, etc. The nominal volume generally denotes the overall volume of the panels including the volume associated with the voids. Similarly, a desired property, such as strength, may be tailored by combining panels together for a net effect or by selecting materials with suitable strength and elasticity characteristics. Panels combined together may also be attached or secured to each other to enhance a desirable property, such as strength. The selection of materials for strength, or for sound or light reflecting or absorbing properties, etc., is well understood and panels according to the invention are well suited to the use of such material.

### BRIEF DESCRIPTION OF THE FIGURES

FIG. 1 depicts a perspective view of a panel according to a preferred embodiment of the invention.

FIG. 2a depicts a partial cross-sectional view of a panel according to an alternate embodiment of the invention comprised of a plurality of structural webs.

FIG. 2b depicts a perspective view of a panel according to an alternate embodiment of the invention comprised of a plurality of structural webs.

FIG. 3 depicts a perspective view of a panel according to another embodiment of the invention having voids concentrated in a localized area of the panel.

FIG. 4a depicts a partial cross-sectional view of a panel according to another embodiment of the invention where voids do not communicate with opposite outer surfaces.

FIG. 4b depicts a partial cross-sectional view of a panel according to another embodiment of the invention where voids communicate with opposite outer surfaces.

FIG. 5 depicts an oblique view of a substantially spherical void according to a preferred embodiment of the invention.

### DETAILED DESCRIPTION OF A PREFERRED EMBODIMENT

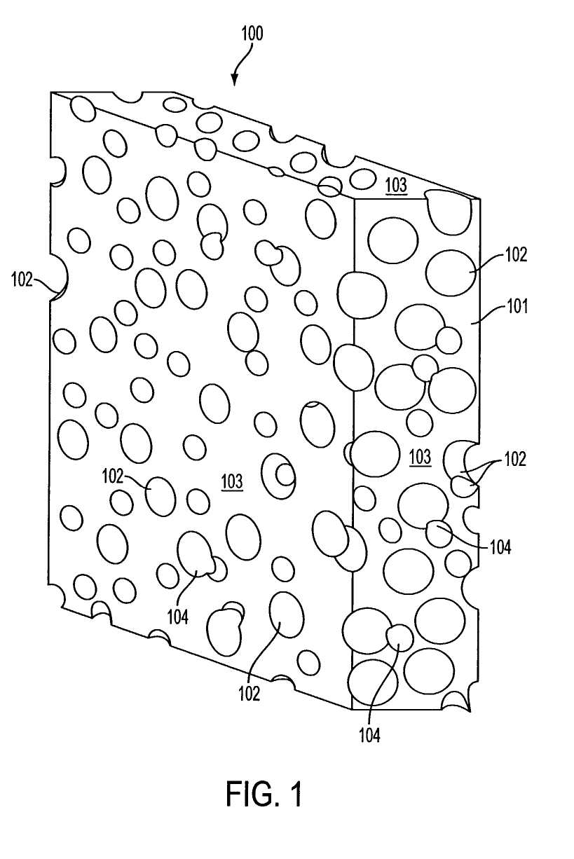

Referring to FIG. 1, a panel 100 useful in architectural design according to the invention comprises a structural web 101 having a plurality of voids 102. Voids 102 may communicate with at least one outer surface 103 of panel 100 and may be of various sizes and shapes, e.g., as substantially spherical in shape, as depicted. In a preferred embodiment, the voids may be disposed in a non-uniform or an apparent random configuration throughout the web 101 to give a perforated appearance resembling a sponge. Optionally, voids 102 may communicate with each other, such as at 104. Panels and webs according to this invention may comprise infinite void configurations to achieve a desired resulting design. For example, voids may be disposed in one or more localized portions of the panel, or they may be disposed such that the voids communicate with a single surface and also not with an opposite surface. Similarly, the voids may be disposed such that the voids communicate with opposite surfaces either directly or indirectly. Voids communicate with opposite surfaces directly when, for instance, the dimensions of the voids exceed the thickness of the panel, and indirectly when individual voids communicating with one surface also communicate with voids communicating with an opposite surface.

A solid content, i.e., a percentage corresponding to the ratio of the volume of the material comprising the web 101 to the total nominal panel volume, i.e., the volume of the panel including the volume of the material comprising the web and the volume of the voids, of panels according to the invention can vary widely, such as from near 100% to arbitrarily low figures. Alternatively, the panel may be described with respect to the volume of voids in relation to the nominal panel volume. For example, a relatively open feel can be provided with a panel having a solid content of approximately 25% or, alternatively described as having voids that occupy approximately 75% of the total nominal panel volume. A lower limit of solid content is generally dependent on the material to use used in the panel and upon the manner in which the panel is to be supported and used, such as for use as structural elements in building construction, or to support the weight of objects, such as clothes placed on hangers and suspended from the voids therein or objects placed on shelves or tables made of the panel according to this invention. For some structural applications solid contents of 25% or even lower have been used. The lower limit is not fixed; rather, it is a function of the material used to produce the panel. For example, for a particular application, the lower limits of solid content for panels constructed of aluminum would typically be lower than for panels constructed of silicone rubber.

In a preferred embodiment, the size of the voids of panels according to this invention may be comprised of substantially spherical voids of various sizes having at least one of: average diameters of approximately 0.25 inch to approximately 4.5 inches, and having a volume between approximately 50 cc and approximately 650 cc. The average diameter of a single substantially spherical or ellipsoidal void may be thought of as the arithmetic mean of the particular diameters of the void as expressed in a three-dimensional reference system. Panels with this configuration have voids that are easily visible and may be useful for decoration and for partitioning space, and also for supporting merchandise, such as hanging clothing in retail clothing establishments. This configuration facilitates use of the panels for hanging merchandise such as clothing on hangers, while reducing the likelihood of users catching fingers, clothing, and other items in the voids. Additionally, bevels or other blunting applied to the edges of voids communicating with panel surfaces further prevents snagging and cutting of objects such as clothing and fingers. In a preferred embodiment, beveling having radii greater than 1/32 inch may be incorporated in panels used in retail clothing establishments.

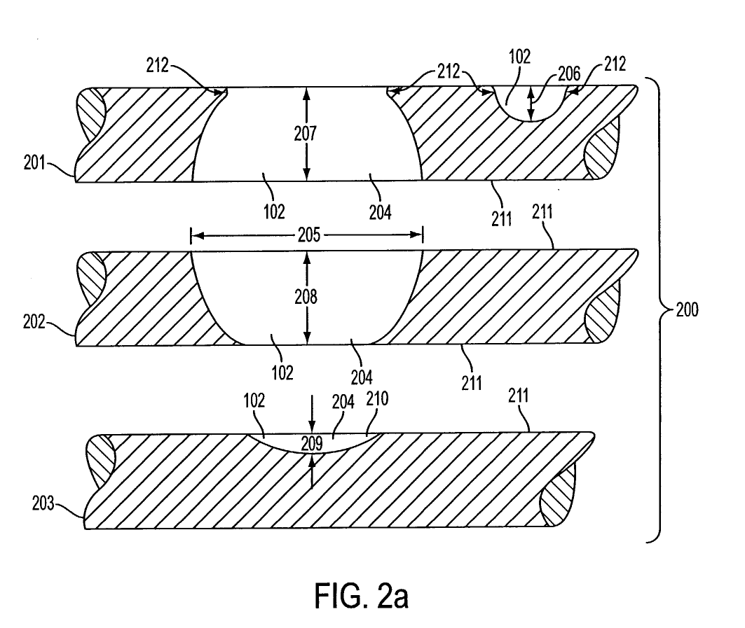

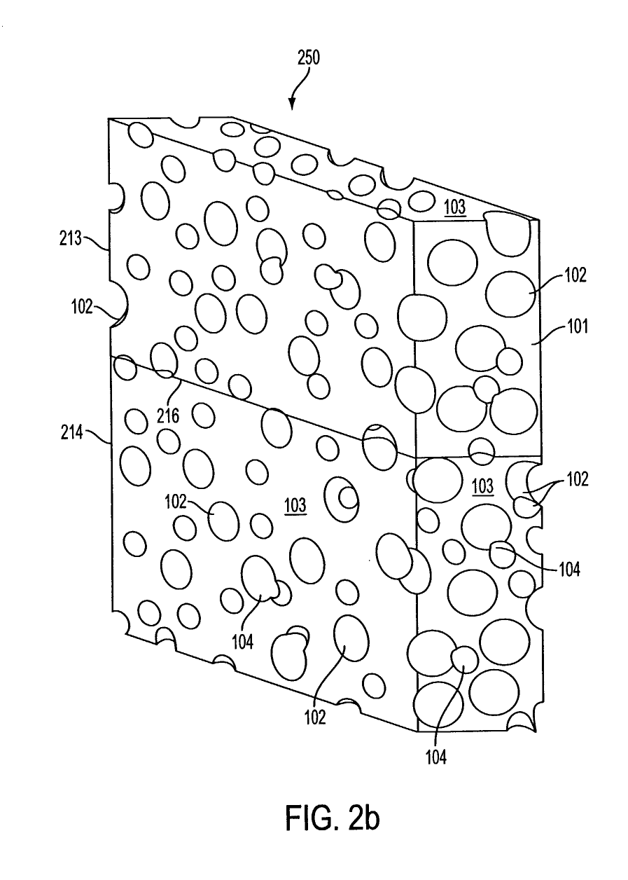

Referring to FIG. 2a, panels having voids communicating with one or more surfaces of the panel, and a depth of more than one-half the diameter of the void, may be fabricated with a plurality of structural webs abutted to each other, i.e., multi-level construction, to yield a single apparently seamless panel. This method of fabricating panels facilitates the use of molds and avoids the necessity of making undercuts.

In a preferred embodiment of multi-level construction, a panel 200 according to this invention may comprise multiple structural webs 201, 202, and 203, having voids 102 which comprise diameter 205 and depths 206. The depth 206 of void 204 may be expressed as the sum of thicknesses 207 and 208, and the depth 209 of void portion 210. Webs 201, 202, and 203 may be milled, molded, or otherwise formed, without for example a necessity for making undercuts, and adhered or otherwise affixed to each other at outer surfaces 211 to make a single apparently seamless panel 200 without apparent discontinuity at the seam or seams comprising a void 204 having a depth 206 of more than one-half its diameter 205. Voids 102 may further comprise beveling at externally exposed edges 212, to prevent snags and cuts by users or objects coming into contact with the edges.

Referring to FIG. 2b, large panels may be fabricated with a plurality of webs abutted to each other at their ends to form a single apparently seamless panel without apparent discontinuity at the seam. This facilitates the shipping of panels and also the moving of panels through doors, into elevators, up or down stairs, etc. In an alternate embodiment of multi-level construction, a panel 250 may comprise structural webs 213 and 214 abutted to each other at outer surfaces or edges 216 form a single apparently seamless panel.

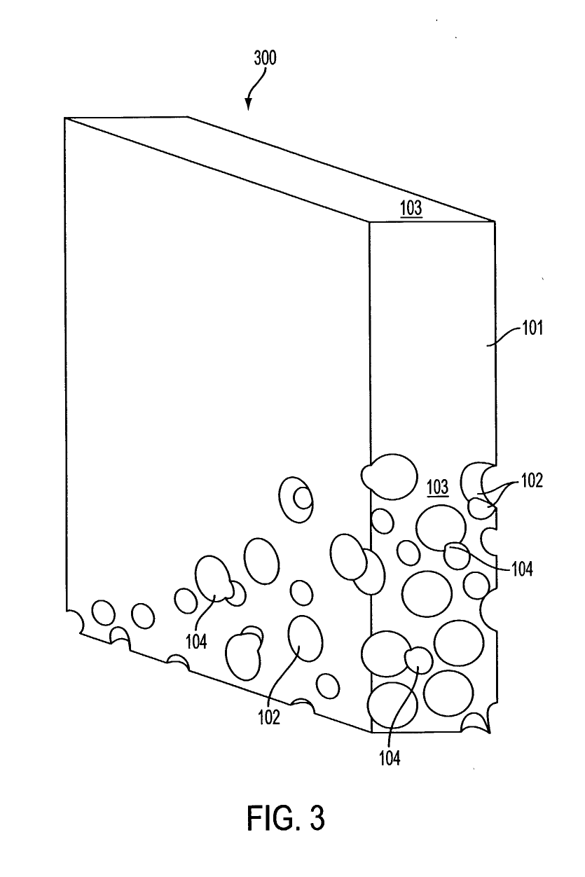

Referring to FIG. 3, a panel 300 according to an alternate embodiment of this invention may comprise a structural web 101 having a plurality of voids 102 disposed in localized or concentrated portions of the panel 300.

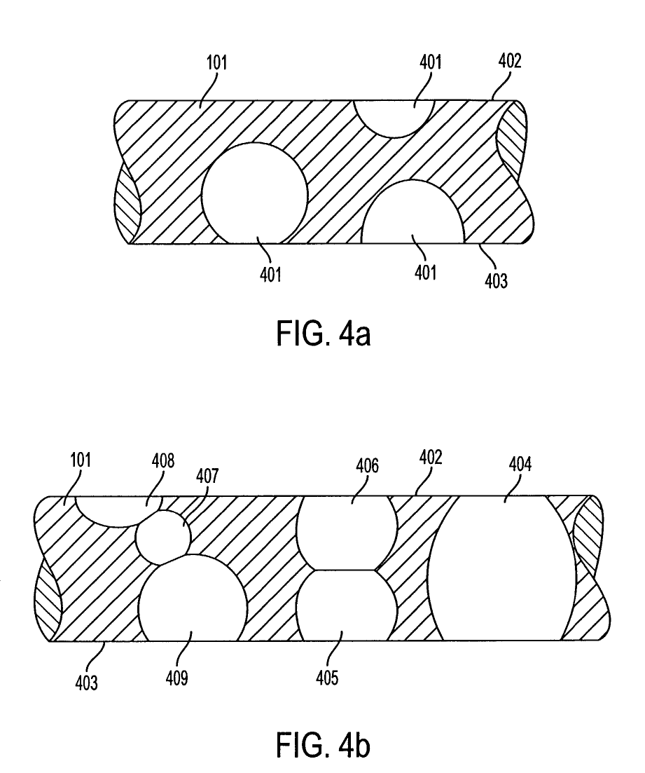

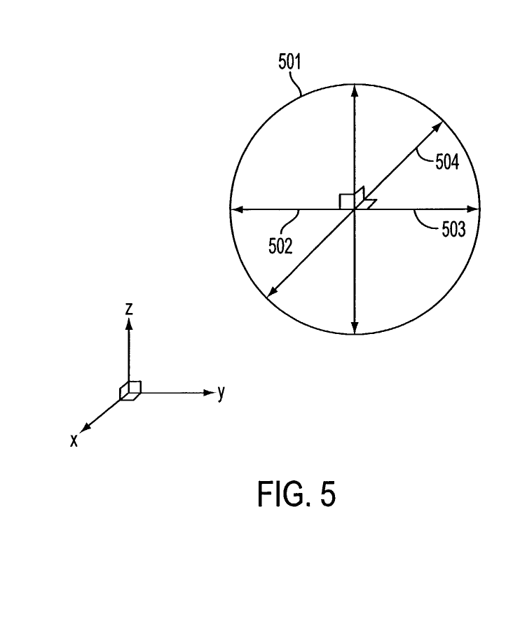

The voids may be disposed in a variety of configurations. For instance, the voids may be disposed such that voids communicating with an outer surface do not also communicate with an opposite surface. Referring to FIG. 4a, a panel may comprise a web 101 having voids 401 disposed such that the voids 401 communicate with a single outer surface 402 or 403 and also not with an opposite outer surface. Similarly, the voids may be disposed such that voids communicate with opposite surfaces either directly or indirectly. Referring to FIG. 4b, void 404 communicates directly with outer surface 402 and with outer surface 403 that is opposite to outer surface 402. Voids communicate with opposite surfaces indirectly, for example, when void 405 that communicates with outer surface 403, also communicates with void 406 that communicates with outer surface 402, and when voids 408 and 409 that communicate with outer surface 402 and 403 respectively communicate with a common void 407.

Referring to FIG. 5, the average diameter of a substantially spherical or ellipsoidal void may be derived by averaging the particular diameters associated with each of the dimensions of a three-dimensional reference system. For example, the average diameter for void 501 is the arithmetic mean of diameters 502, 503, and 504.

The embodiments described above are provided by way of illustration only and should not be construed to limit the invention. Those skilled in the art will readily recognize various modifications and changes may be made to the present invention without departing from the true spirit and scope of the present invention. Accordingly, it is not intended that the invention be limited, except as by the appended claims.

1. A panel for architectural design, comprising:
a structural web having a plurality of voids, the voids disposed in an non-uniform configuration, at least some of the plurality of voids communicating with at least one outer surface of the panel, giving the at least one outer surface a perforated appearance.

2. A panel for architectural design, comprising:
a structural web having a plurality of voids, the voids disposed in an apparently random configuration, at least some of the plurality of voids communicating with at least one outer surface of the panel, giving the at least one outer surface a perforated appearance.

3. The panel of claim 2, wherein the apparently random configuration is random.

4. The panel of claim 2, wherein at least some of the plurality of voids communicating with an outer surface do not also communicate with an opposite surface.

5. The panel of claim 2, wherein at least some of the plurality of voids communicate with each other.

6. The panel of claim 2, wherein inner surfaces of the panel defining the voids are continuously curved.

7. The panel of claim 6, wherein the voids comprise an average diameter between approximately 0.25 inch and approximately 4.5 inches.

8. The panel of claim 6, wherein the continuously curved inner surfaces are substantially spherical.

9. The panel of claim 2, wherein the voids occupy less than or equal to about 75% of a total nominal panel volume.

10. The panel of claim 2, wherein the web has a solid content greater than or equal to about 25% of a total nominal panel volume.

11. The panel of claim 2, wherein at least some of the voids are located in predetermined locations to allow a plurality of panels to be abutted with each other without apparent discontinuity at the seam.

12. The panel of claim 2, wherein voids communicating with the outer surface of the panel have beveled radii of at least about 1/32 inch.

13. The panel of claim 2, wherein the structural web is formed of a material capable of curing into a suitably rigid structure.

14. The panel of claim 2, wherein the voids are concentrated in at least a portion of the panel.

15. The panel of claim 2, wherein the voids are between approximately 50 cc and approximately 650 cc in volume.

16. A panel for architectural design, comprising:
a plurality of structural webs, the webs each having a plurality of voids disposed in an apparent random configuration, at least some of the plurality of voids communicating with an outer surface of the panel giving the surface a perforated appearance, and the webs abutting with each other to form a single apparently seamless web.

17. A panel for architectural design, comprising:
a structural web having a plurality voids wherein inner surfaces of the web defining the voids are substantially spherical, the voids disposed in an apparently random configuration, and at least some of the plurality of voids communicating with at least one outer surface of the panel, giving the at least one outer surface a perforated appearance.

18. A panel for architectural design, comprising:
a structural web, having a plurality of substantially spherical voids disposed in an apparently random configuration, at least some of the plurality of voids communicating with at least one outer surface of the panel, giving the at least one outer surface a perforated appearance, and the voids having at least one of:
an average diameter ranging in size between approximately 0.25 inch and approximately 4.5 inches, and
a volume between approximately 50 cc and approximately 650 cc.

19. An panel for architectural design, the panel partially hollowed in a non-uniform pattern of voids, the voids breaching an outer surface of the panel, giving the outer surface a perforated appearance.

20. A method of manufacture of a panel for architectural design, comprising:
placing in a mold a plurality of objects with an approximate shape and size of a desired shape and size of a plurality of voids;
placing curable material in the mold with the objects; and
removing the objects from the mold after the curable material placed in the mold has cured.

21. The method of claim 20, wherein the objects comprise are at least one of:
a plurality of balloons; and
a plurality of balls.

22. The method of claim 20, wherein the objects are destructively removed from the mold.
